(19) United States
(12) Patent Application Publication
(10) Pub. No.: US 2003/0061611 A1
(43) Pub. Date: Mar. 27, 2003

(54) Notifying users of available content and content reception based on user profiles

(76) Inventor: Ramesh Pendakur, Hillsboro, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/965,531

(22) Filed: Sep. 26, 2001

(51) Int. Cl. H04N 5/445; G06F 3/00; G06F 13/00

(52) U.S. Cl. 725/46

(57) ABSTRACT

A digital content transmission and reception system that uses a profile to notify a user of content is described. The content transmission and reception system compares a user profile with descriptive data for entertainment content that is to be simultaneously broadcast to the user and causes a notification system to notify the user when the content is of probably interest.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright© 2001, Intel Corporation, All Rights Reserved.

### BACKGROUND OF THE INVENTION

1. Field of the Invention

The invention relates generally to transmission and reception of digital data. More particularly, the invention relates to a system and method for using a notification system to notifying a user of content that matches a profile.

2. Background Information

Television viewers often use television program guides to discover television programming of interest. Traditionally, television viewers have used standard paper television programming guides that list expected television programming by date, time, and channel. These paper guides are difficult and time consuming to use. Often television programming of interest may not be discovered using such guides.

More recently, electronic versions of these paper television program guides have become available to a limited extent on certain digital televisions. FIG. 1 shows a prior art use of such an electronic television program guide. A television viewer 110 uses a remote control device 120 to turn on a digital television 150. The television viewer uses a program guide button 140 to turn on a program guide 170 on a display 160 of the digital television 150. The program guide 170, as well as television programs may come from a link to a satellite dish 190.

The guide 170 comprises a plurality of programs 172-180 including a program of interest 176 that the television viewer 110 would like to locate in the program guide 170 and watch. The television viewer 110 may use guide selection buttons 130 and in particular the down button 135 to scroll downward through the programs 172-180 of the program guide 170 starting with program 172. Unfortunately, there may be a large number of programs 174 that the television viewer 110 may need to scroll through before discovering the program of interest 176. That is, the program of interest 176 may be hidden within a large number of programs 174 between the first program 172 and the last program 180. This sort of program guide 170 does not significantly improve the odds that the television viewer 110 discovers the program of interest 176 compared to paper guides or compared to flipping channels. Accordingly, often the television viewer 110 equipped with the program guide 170 does not discover the program of interest 176.

### BRIEF DESCRIPTION OF THE SEVERAL VIEWS OF THE DRAWINGS

The novel features believed characteristic of the invention are set forth in the appended claims. The present invention is illustrated by way of example, and not by way of limitation, in the figures of the accompanying drawings and in which like reference numerals refer to similar elements. The invention itself, however, as well as a preferred mode of use, will best be understood by reference to the following detailed description of an illustrative embodiment when read in conjunction with the accompanying drawings:

FIG. 1 illustrates a prior art digital television system and program guide.

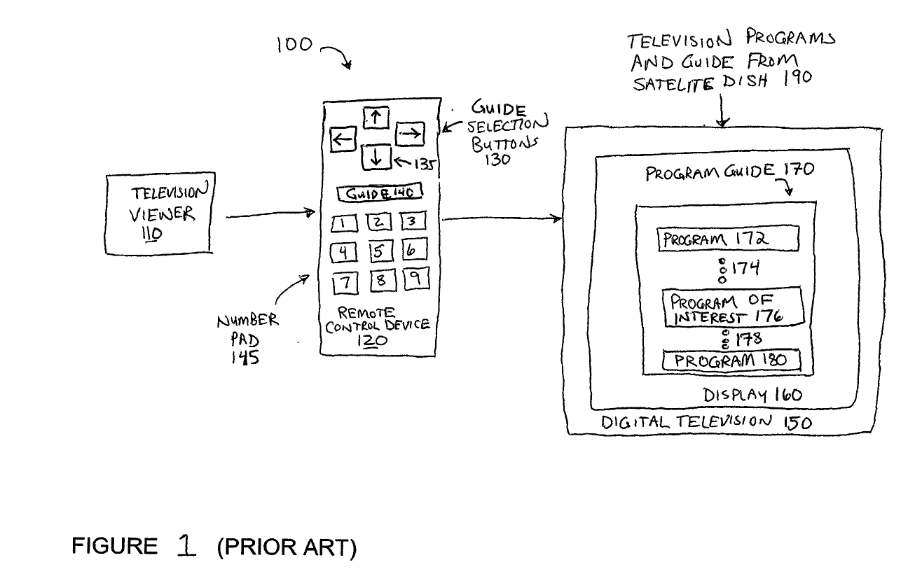

FIG. 2 illustrates a profile based content transmission, reception, and notification system, according to a first embodiment of the present invention.

FIG. 3 illustrates a profile based content transmission, reception, and notification system, according to a second embodiment.

FIG. 4 illustrates in block diagram form a method, according to one embodiment, for notifying a user regarding content transmission.

FIG. 5 illustrates in block diagram form a method, according to one embodiment, for determining whether to notify a user by comparing content descriptive data and profile preference data.

FIG. 6 illustrates in block diagram form a method, according to one embodiment, for notifying a user by creating a notification based on notification address data, notification format data, and content descriptive data.

FIG. 7 illustrates content containing exemplary descriptive data, according to one embodiment.

FIG. 8 illustrates a user profile containing exemplary data and preferences, according to one embodiment.

FIG. 9 illustrates a content notification system presenting an exemplary notification of content, according to one embodiment.

FIG. 10 illustrates in block diagram form a method, according to one embodiment, for transmitting content.

FIG. 11 illustrates an exemplary content reception system comprising a digital television that provides content notification based on a profile and that collects and provides profile feedback, according to one embodiment.

FIG. 12 illustrates an exemplary content transmission, reception, and notification system that includes a profile that is accessible to a user via the Internet.

FIG. 13 illustrates a computer system upon which one embodiment may be implemented.

### DETAILED DESCRIPTION OF THE INVENTION

In the following description, for the purpose of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

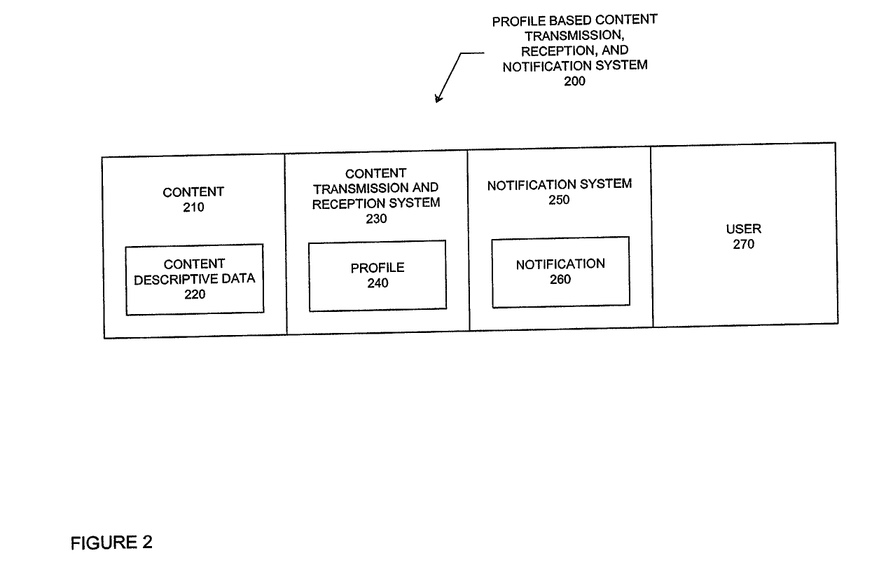

FIG. 2 conceptually illustrates a profile based content transmission, reception, and notification system, according to a first embodiment. Content 210 is accessed by a content transmission and reception system 230 and provided to a user 270. The content 210 comprises content descriptive data 220 that describes the content 210, and the system 230 comprises a profile 240 that may be compared with the descriptive data 220 to determine whether to provide a notification 260 to the user 270 on a notification system 250. The profile 240 may allow content 210 which is of likely interest to the user 270 to be proactively determined and prefetched into a reception system of the user 270 and the profile 240 may allow the user 270 to be selectively and proactively notified of the content 210 by the notification system 250 based on properties of the content 210 and in particular, based on the content descriptive data 220. The profile 240 may allow content of probable The profile 240 may contain any type of knowledge to allow the notification that is desired for the particular implementation. For example, this knowledge may include preferences, conditions, constraints, matching criteria, or other knowledge. Advantageously, in this way, the user 270 may be pro-actively and selectively notified of content of interest, which may increase the likelihood that the user 270 discovers and enjoys favorable content.

The content 210 may be any type of content desired for the particular implementation and is to be interpreted broadly. By way of example, the content 210 may be entertainment content, educational content, business content, computer software, multimedia (e.g., movies, video on demand, video games), video, audio (e.g., MP3s), and other types of content (e.g., structured data). Typically, the content 210 will include content descriptive data 220 that describes the content. The content 210 may have a digital format and digital processing may be used on the content 210 including storage, electronic manipulation, perfect copying, compression, transmission, and others. For example, an identical copy of the digital content 210 may be created and a bit-wise comparison of the original and the copy may be used to verify that the two are identical.

The content 210 is in an electronically accessible format. Typically, the content 210 will exist as a computer file having a particular file format that is compatible, standard, or efficient for the type of content and will be stored in a memory. For example, in the case of audio content 210, the file format may be an MP3 format and the content 210 may be stored in a memory representing an audio library. However, other embodiments are contemplated. For example, according to one embodiment, the digital content 210 exists as a stream of digital data. The stream of digital data may be provided by a digital data generating device (e.g., a digital camera/recorder), may be provided by an electronically connected source or provider (e.g., a news feed or a stock ticker), or may be provided by another functionally connected entity. In any event, the content 210 is accessible to the content transmission and reception system 230.

The content 210 includes the content descriptive data 220. The content descriptive data 220 may contain data that describes attributes and characteristics of the content 210, when the content 210 is transmitted, how the content 210 is transmitted, and other data. Typically, the content descriptive 220 data will be separate from the actual portion of the content 210 that is actually presented to the user 270, although other embodiments are contemplated, such as those where the content descriptive data 220 is sampled, from within the presented content. For example, the data 220 may indicate content type (e.g., sports, movie, sitcom, mini-series, news, music), content category (e.g., hockey, comedy, action, science fiction, horror, jazz, blues), content subject matter (e.g., Colorado Avs, technology, cooking, travel), and other information.

The content transmission and reception system 230 accesses or obtains the content 210, transmits it, receives it, and interacts with the notification system 250. The content transmission and reception system 230 may be any transmission and reception system sufficient to transmit and receive content and to use a profile 240 for notification purposes. The system 230, or any portion thereof, may contain hardware, firmware, and software, or any combination.

According to one embodiment, conventional technologies may be used, together with any desirable modifications that will be apparent to those skilled in the art based on the discussion herein, to perform the transmission processing, transmission, reception, and reception processing of the content 210 and messages or requests associated with notification. For example, the system 230 may comprise a conventional processor to execute instructions, a conventional memory to store content, a conventional encoder to encode content, a conventional transmitter to transmit a content containing signal, a conventional receiver to receive the content containing signal, and a conventional decoder to decode content. Without limitation, the content may be converted to an Moving Picture Experts Group (MPEG) format, transmitted via an tower antenna over an atmospheric communication medium, received by an antenna, and converted from the MPEG format to an uncompressed useable format.

Typically, the system 230 may comprise a transmission subsystem to transmit the content and a content reception subsystem to receive the content. The term “transmission” and related terms will be used broadly to refer to moving data, frequently digital data, from one place or system to another and the term “reception” and related terms will be used broadly to refer to accepting the moved data. Typically, transmission will include generating and submitting a content-containing machine-accessible signal and receiving will include accepting and interpreting the content-containing machine-accessible signal. For example, a transmission tower may broadcast an electromagnetic radiation content-containing signal simultaneously to multiple receiving antennas (e.g., rabbit ear antennas) operable to accept the signal. Alternatively, rather than broadcasting, the signal may be narrowcast to specific recipients, similarly to the way cable television is delivered to cable subscribers.

According to one embodiment, the content transmission subsystem transmits the content 210 over a substantially one way communication link, in which the predominant or only transmission is from the transmission subsystem to a reception subsystem. In one embodiment, the link may be bi-directional, although typically, the link will be a substantially non-client-server link. A client server link would be typified by the reception subsystem issuing a request for the content 210 and the transmission subsystem then issuing the content 210 in response, similarly to the way that a web page may be received using the Internet. In contrast, in a non-client-server link, the transmission subsystem may provide the content 210 without the request. That is, the content transmission subsystem may transmit content 210 to the content reception subsystem, and typically a plurality of other content reception subsystems simultaneously, without receiving a specific request that is processed and responded to or supplied.

Typically, the link will be a link that is shared by multiple reception systems such as the described reception subsystem. The link may be based on a number of technologies, including satellite and dish, fiber optic, coaxial cable, and others. For example, the link may be a one way broadcast pipe in which the content 210 is simultaneously broadcast to all of the recipients connected with a network (e.g., having an antenna like rabbit ears or a satellite dish to receive the transmission) or narrowcast to a select group of recipients (e.g., having authorization to receive the transmission). For illustration and without limitation, the link may carry a digital TV channel with a bandwidth of 19.39 megabits per second and may be partitioned among multiple channels such as four channels that each carry 4.85 megabits per second, which may carry either content or retransmitted content.

Typically, the system 200 includes a content reception subsystem to receive the content 210. The reception subsystem may include a receiver interface to receive a content containing signal, a decoder to decode the signal, a memory to store the content, and a processor to execute instructions, such as instructions to determine that the content 210 has been received, to generate a request that the notification system 250 issue the notification 260, and to transmit the request. By way of example, without limitation, the receiver, the decoder, the memory, the processor, and/or the instructions may be included in a computer system, a personal computer, a digital television having a memory and a processor, a set top box, a personal video recorder, a sound system having a memory and a processor, or other systems. The receiver may be an antenna (e.g., rabbit ears, satellite dish, etc.) or other receivers. The content reception subsystem may have different levels of intelligence, as desired, such as intelligence to know to connect and receive the content 210 (e.g., tune to a particular channel to receive a corresponding predetermined broadcast transmission) and to have intelligence to receive and use a schedule of content broadcasts (e.g., to use a conceptual TV guide).

Depending on the particular implementation, the reception subsystem may or may not include a content presentation system (e.g., a digital television) that is capable of presenting the digital content 210 in a human consumable format (e.g., as video presented on a display device). According to one embodiment, the reception subsystem has a content presentation subsystem to directly present the content 210 to the user 270. For example, the reception subsystem may include a digital television, a personal video recorder, a stereo, an MP3 player, a CD ROM burner, or another content presentation subsystem. Alternatively, the reception subsystem may not include a content presentation system. The reception subsystem may present the content 210 to a recipient content presentation system that is functionally, electrically, and/or physically coupled with the reception subsystem that presents the content 210 to the user subscriber, viewer, or listener 270. Typically, the objective of the system 200 is to present entertainment data to the user 270, however the invention is not so limited.

The content transmission and reception system 230 comprises the profile 240 that is used to provide the notification 260. Typically, the profile is associated with the user 270. The profile 240 may be a user profile that corresponds to a single user 270, a family profile that corresponds to a family including user 270, a device profile that corresponds to a device associated with or corresponding to user 270, a business profile that corresponds to a business or business group that includes user 270, a demographic profile that affects a demographic segment (e.g., the elderly, a particular race, a particular religion) that includes user 270, or a geographic profile that affects a geographic location (e.g., the Willamette valley) associated with or corresponding to the user 270. Thus, the profile 240 may be a singular or group profile. Other profiles are contemplated.

The profile 240 may include user information (e.g., characteristics and attributes of the user 270, billing information, address information), content preference information that indicates types of content (e.g., sports) and characteristics of content (e.g., major sporting event) that the user 270 prefers, timing preference information that indicates when the user prefers to receive or consume the content 210, observational profile information based on automated observation and profile recordation of content consumption behavior of the user 270 and/or direct contribution of profile data by the user 270, and notification preference information that describes when and how the user prefers to be notified of content. According to one embodiment, the profile may contain information or data operable to differentiate or identify desired or preferred content from undesired or un-preferred content.

A number of ways are contemplated for providing the notification 260 using the content descriptive data 220 and the profile 240. Typically, the data 220 may be compared with the profile 240 and the comparison may result in the notification 260. The comparison is to be interpreted broadly to cover a number of comparisons discussed as well as those that that will be apparent to those having an ordinary level of skill in the art and having the benefit of the present teachings. According to one embodiment, the content descriptive data 220 and the profile 240 contain one or more corresponding pairs of keywords or other identifiers. For example, the content 210 may include The Matrix, available from Warner Brothers, the content descriptive data 220 may include a unique identifier corresponding to The Matrix, the profile 240 may contain the same unique identifier, and the content transmission and reception system 230 may detect that they are the same and request the notification 260 from the notification system 250. According to another embodiment, the content descriptive data 220 contains a first plurality of keywords (e.g., including science fiction, action, Keanu Reeves), the profile contains a second plurality of keywords (e.g., including science fiction, action), and the system 230 determines that the first plurality and the second plurality are sufficiently similar or matching to merit the notification 260, which may be requested.

According to one embodiment, when it is determined to cause the notification system 250 to provide the notification 260, the system 230 provides a signal, message or other communication that will be called a request for notification to the notification system 250. The request for notification may correspond to the notification system 250 and may be different for different notification systems 250. According to many embodiments, the notification system 250 may be an electronic system that may notify the user 270 via a stimulus such as sound, display (text or graphics), color, vibration, or other stimulus. According to one embodiment, the notification system 250 may be a sufficiently small, wireless, handheld, mobile, network access device that may be proximate to a non-stationary user. The notification system 250 may be a substantially unmodified conventional electrical system, such as a pager, a telephone (e.g., a cell phone), a personal digital assistant (PDA), a personal computer, a laptop, an email account, any type of computer system, or another system that is convenient for the particular implementation. Although the notification system 250 may be conventional, those skilled in the art will appreciate that advantageous modifications of the systems are contemplated. For example, in the case of a PDA, instructions may be provided to create calendar entries based on the request for notification and use delayed notification capabilities provided by the PDA.

According to one embodiment, the system 230 includes novel software instructions to compare the profile 240 with the content descriptive data 220 and prompt the notification system 250 to present the notification 260. The instructions will typically depend on the business environment and objectives of the particular implementation. The instructions may comprise notification request generating instructions, formatting instructions that at least partially format the notification based on the content descriptive data, and addressing instructions that use an address to locate and transmit the notification request to the notification system 250.

Accordingly, the system 200 may use the profile 240 to notify the user 270 when the content 210 is of probable interest to the user 270. Advantageously, this notification 260 may provide the user with increased awareness of the right kind of content, making the system 200 and associated services more useful, valuable, and enjoyable to the user 270.

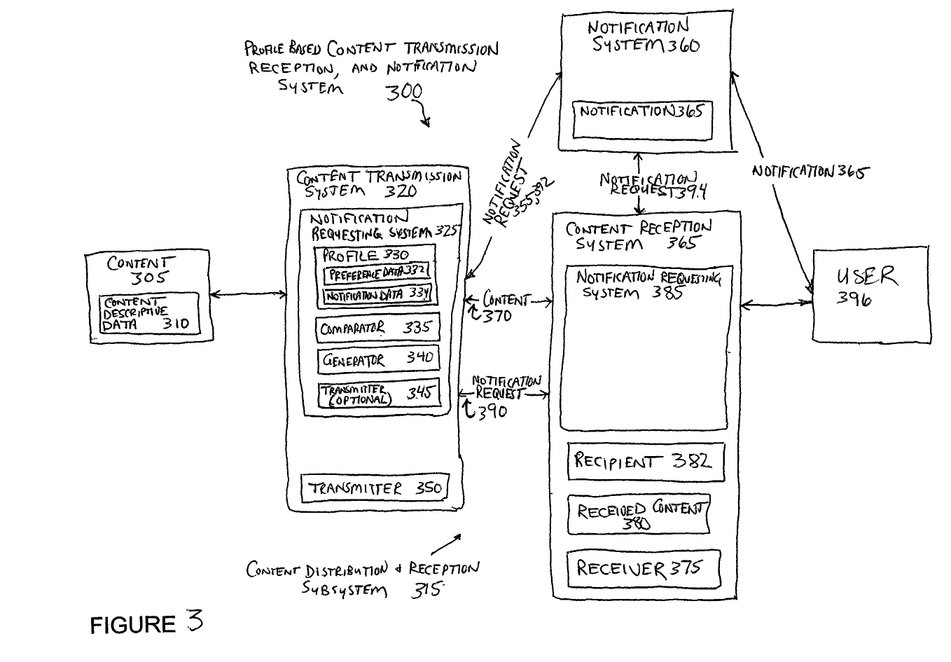

FIG. 3 conceptually illustrates a profile based content transmission, reception, and notification system 300, according to a second embodiment. Content 305 containing content descriptive data 310 is accessed by a content transmission system 320 of a content distribution and reception subsystem 315. The system 320 contains a notification requesting system 325 to determine whether to notify users including user 396 of the content 305. The notification requesting system 325 contains a profile 330 that contains preference data 332 that describes content consumption preferences of the user 396 and notification data 334 that contains information relevant to notifying the user 396, such as when and how the user prefers to be notified.

A comparator 335 of the system 325 compares the content descriptive data 310 and the profile 330 to determine whether the user 396 should be notified about the content 305. The comparator 335 may comprise data structure or keyword comparing instructions that compare descriptive data 310 with preference data 332 and assess whether the data 310 sufficiently matches the profile 330. For example, the comparator may determine whether the content 305 satisfies a predetermined condition, criteria, or constraint associated with the user 396 and reflected in the profile 330, based on the data 310.

Without limitation, consider the following simple exemplary conceptual comparison based on a matching score: “for each of the alphanumeric keywords in the content descriptive data 310, if the profile 330 contains the alphanumeric keyword then increment a score for the content, where the score empirically quantifies a similarity of the content 305 with the profile 320”. The described matching score may be used to determine whether the user 396 is notified of the content 305. For example, the user may be notified if the score is greater than a threshold, such as a statistically derived threshold for all content (e.g., a sufficiently high percentile in a distribution of scores for a large number of content or a predetermined number (e.g., 10)). The threshold may be user-adjustable.

If it is determined that the user 396 should be notified, a generator 340 of the system 325 generates a request for notification 355. According to one embodiment, the generator 340 references the notification data 334 to determine characteristics of the notification system 360. For example, the generator may determine that the notification system 360 is a pager that supports alphanumeric messages up to a length of 250 total characters, the pager has an address of 503-264-0572, and that the user 396 prefers to be notified 1 day before viewing time. Then, the generator 340 may reference the content descriptive data 310 and generate a request for notification 355 containing a message describing the content 305 and addressed to the notification system 360. For example, message may include “THE MATRIX—STARRING KEANU REEVES—SATURDAY JUNE 30—7:00 P.M. MST—****”, and the message may have a header including the address “503-264-0572” and the notification time “6-29-01-19:00”. The asterisks may be based on the score and may represent how well the content 305 is estimated to appeal to the user 396.

The system 325 may provide the request for notification 355 to a transmitter 345 that is operable to transmit the request to the notification system 360 at the time indicated in the header (e.g., 6-29-01-19:00). The transmitter 345 may send the request for notification 355 to the notification system 360, which may present the notification 365 to the user 396. For example, the notification system 360 may be a pager with a notification 365 that beeps and vibrates to alert the user of an alphanumeric message displayed on the pager, such as “THE MATRIX—STARRING KEANU REEVES—SATURDAY JUNE 30—7:00 P.M. MST—****”.

The user 396 receives the notification 365 and may respond to the notification 365. For example, the user 396 may indicate an interest or a disinterest in the content 305 using a data input device of the notification system 360. This interest or disinterest may encourage or prevent messages related to the content 305, either locally at the notification system 360 or by informing the content distribution and reception subsystem 315. The user 396 may also respond to the notification 365 by clearing the notification 365 without indicating interest or disinterest.

The content 305 is transmitted to the content reception system 365. Typically, the transmission of the content 305 is scheduled, and this schedule may be based on the profile 330, including user preference data 332 and notification data 334. The content 305 may be processed for transmission and transmitted on a link 370 that may include electromagnetic radiation, satellite, fiber optic, cable, and others. According to one embodiment, the content 305 may be processed for transmission over a one way broadcast pipe link 370 involving a satellite or transmission tower, and transmitted to a plurality of compatible receivers including receiver 375 corresponding to the content reception system 365. The receiver 375 may be any conventional receiver, such as rabbit ears, a satellite dish, an interface to a cable service, etc. The receiver 375 is used to obtain received content 380.

The content reception system 365 comprises a notification requesting system 385. The notification requesting system 385 may be thin or thick in terms of notification processing. That is, depending on the particular implementation, the system 385 may be independently able to generate and transmit requests for notification 394 to the notification system 360 or may communicate indirectly with the system 360 via at least partial reliance on the system 325. According to one embodiment, the system 385 includes a profile, a comparator, a generator, a transmitter, and other desired functionalities. For example, the notification requesting system 385 may generate a request for notification 394 and transmit the request for notification 394 to the notification system 360. The notification request 394 may result in the exemplary notification 365, “THE MATRIX IS AVAILABLE FOR VIEWING ON CHANNEL 31”. The notification requesting system 385 may be implemented at least partially in software instructions that may be provided to the content reception system 365 via a communication link, such as the link 370.

Alternatively, the notification requesting system 385 may communicate with the notification requesting system 325 to issue a notification request 392, typically by a second communication link 390, rather than communicating directly with the notification system 360. For example, the system 365 may indicate completion of reception of the received content 380 to the system 325, wherein the system 325 provides notification request 392 to the notification system 360. The request 392 may prompt the system 360 to display the notification 365, such as “NOW READY FOR VIEWING—THE MATRIX—STARRING KEANU REEVES—****”. This approach may simplify the system 385.

As stated above, the request for notification from the system 385 to the system 325 may be done on a second link 390 that is different than the link 370. Advantageously, using different links may allow the link 370 to be selected based on attributes desirable for content delivery and the link 390 to be selected based on attributes desirable for transmitting a request for notification. Typically, the link 390 will not need large bandwidth and will have less total bandwidth than the link 370. The link 390 may provide an affordable way for the reception system 365 to provide the request for notification. For example, the link 390 may support an affordable, compact, widely available, robust, or otherwise desirable transmitter. The link 390 may be one way or bi-directional, as desired. Other desirable qualities for the link 390 of certain embodiments include existing availability to many residences and businesses, ease of installation or activation, low cost per unit bandwidth. According to one embodiment, the link makes use of a wire-based link available at a business or residence associated with the reception system. For example, the link 390 may include a telephone line, digital subscriber line (DSL), coaxial cable, a link to the Internet, and others.

The content reception system 365 may also comprise a recipient 382 to present the received content 380 to the user 396. The recipient may be any content presentation device, such as a television, a digital television, a video recorder, a CD ROM recorder, a stereo, and others.

Advantageously, the described notification system may increase the likelihood that the user 396 discovers and consumes content of interest. This pro-active notification approach, which involves the user 396 prior to content consumption, may increase the satisfaction of the user 396 and may stimulate use of the system 300 for content delivery. This feature may be desirable to broadcasters, content aggregators, and personal video recorder (PVR) companies, who may all use embodiments to offer value-added content delivery.

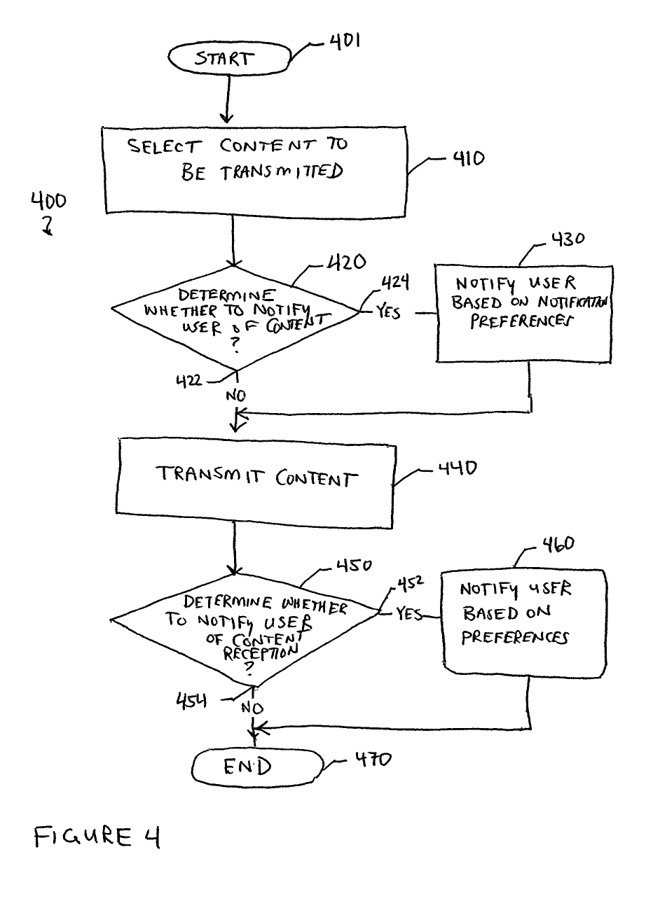

FIG. 4 conceptually illustrates in block diagram form a method 400, according to one embodiment, for notifying a user regarding content transmission. The method 400 may be implemented in logic that may include software, hardware or a combination of software and hardware.

The method 400 commences at block 401, and then proceeds to block 410, where content is selected for transmission. The content may be selected based on examining one or more profiles associated with one or more users and selecting content that is favorable to those users. The content may be scheduled for transmission at a time that is favorable or preferred for the one or more users based on the one or more profiles.

Once content has been selected for transmission, a determination is made at decision block 420 whether one or more users should be notified of the selected content. As stated elsewhere, this may include comparing content descriptive data with the one or more profiles. If “no” is the determination 422, then the method 400 advances to block 440.

The method 400 advances from a “yes” decision 424 to block 430 where a user is notified based on notification preferences. This may include communicating with a notification system with a message or request by using communication information of the notification preferences (e.g., an address of the notification system), and including content descriptive data that informs the notification system and the user of the characteristics or attributes of the content.

The method 400 advances to block 440 where the content is transmitted. This may include performing transmission processing that is conventionally used for the type of content (e.g., digital video, digital audio, Extensible Markup Language (XML), MPEG, MPEG Audio Layer 3 (MP3), and others), for the type of transmission system, and for the type of reception system.

After transmission of the content has completed, and optionally after reception of the content has completed and been confirmed, a determination may be made at decision block 450 whether one or more users should be notified of content reception. According to one embodiment, this determination may be made for a user by referencing notification preferences of the user and determining whether the user prefers to be notified of content reception. Alternatively, this decision may be based on a score that quantifies the match between the users profile and the content. Other determinations are contemplated. If “no” is the determination 454, then the method 400 terminates at block 470. If “yes” is the determination 452 then the method 400 advances to block 460 where the user is notified based on notification preferences, and then the method 400 terminates at block 470. Accordingly, as shown in FIG. 4, a profile based content transmission, reception, and notification system, such as system 200, may cause notification of a user both of content of probable interest that will be available to consume at some future time and content that is available for current consumption by the user.

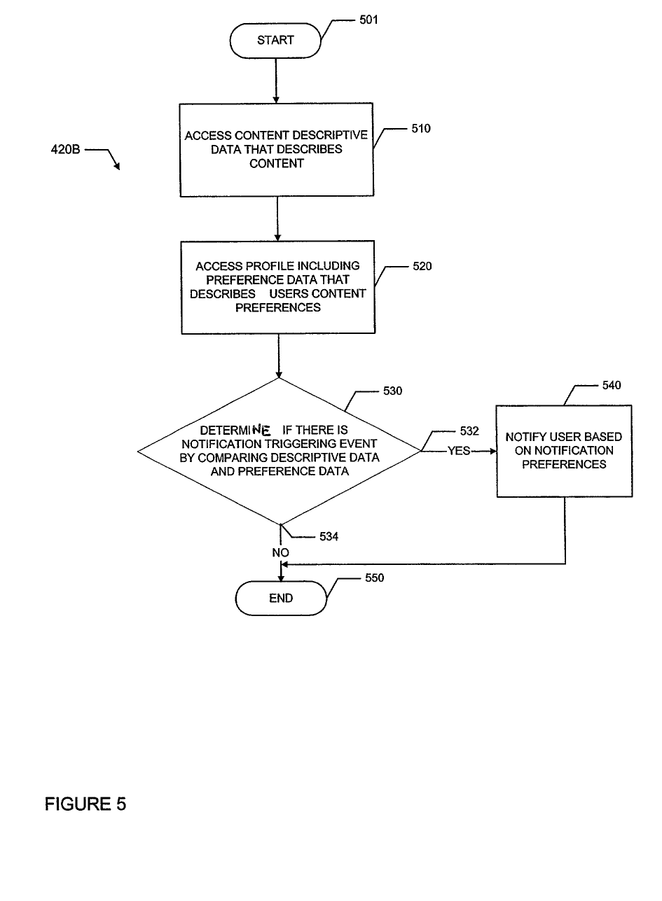

FIG. 5 conceptually illustrates in block diagram form a method 420B, according to one embodiment, for determining whether to notify a user by comparing content descriptive data and profile preference data. The method 420B may be implemented in logic that may include software, hardware or a combination of software and hardware.

The method 420B commences at block 501, and then proceeds to block 510, where content descriptive data that describes content to be distributed is accessed. This data may be a part of the content, such as in a header, or may be separate from the data but contain identifiers that associate the content descriptive data with the content.

The method 420B advances from block 510 to block 520 where a profile comprising preference data that describes the content consumption preferences of one or more users is accessed. Typically, this profile will be accessible to the content transmission system and the content notification system. The profile may also be accessible to the content reception system and the user.

A determination is made at decision block 530 whether there is a notification-triggering event that indicates that one or more users should be notified of the content. The descriptive data may be compared with the preference data to make this determination. If “no” is the determination 534 then the method 420B terminates at block 550. If “yes” is the determination 532 then the method advances to block 540 where the user is notified of the content based on the notification preferences, and then the method 420B terminates at block 550.

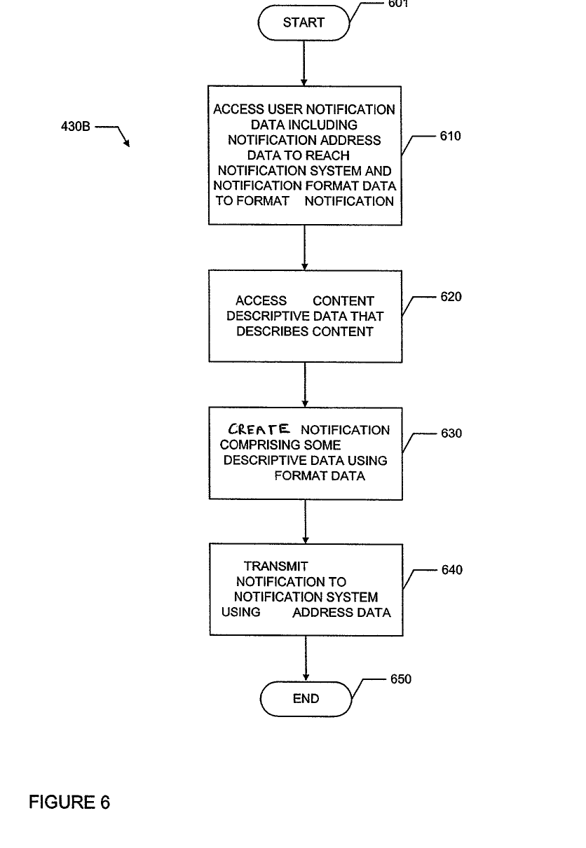

FIG. 6 conceptually illustrates in block diagram form a method 430B according to one embodiment, for notifying a user by creating a notification based on notification address data, notification format data, and content descriptive data. The method 430B may be implemented in logic that may include software, hardware or a combination of software and hardware.

The method 430B commences at block 601, and then proceeds to block 610, where user notification data including notification address data to reach a notification system and notification format data to format a notification are accessed. The data may be accessed from a profile. The notification address data may contain an email address (e.g., ramesh.pendakur@intel.com, a pager or telephone address (e.g., 503-264-0572), a PDA address, and others). The notification format data may contain different format data for different types of notification systems and may format content descriptive data for presentation on the notification system.

The method 430B advances from block 610 to block 620 where content descriptive data that describes content is accessed. The content descriptive data may comprise an assortment of predetermined human-readable keywords.

The method 430B advances from block 620 to block 630 where a notification comprising some of the descriptive data is created using the format data. For example, some of the most informative human readable keywords may be selected and presented in a particular arrangement for display on a notification system.

The method 430B advances from block 630 to block 640 where the notification is transmitted to the notification system using the address data. For example, in the case of an email notification system a request for notification may be transmitted to networked computer system that is reachable by the email address. The method terminates at block 650.

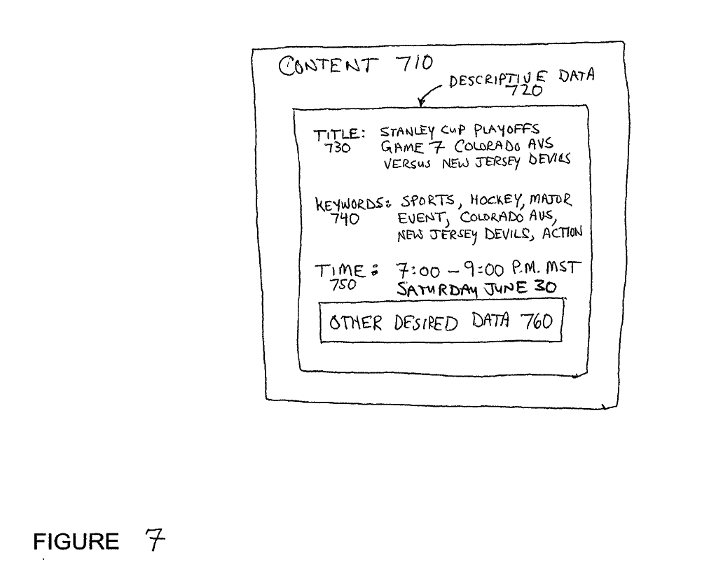

FIG. 7 conceptually illustrates content 710 containing exemplary descriptive data 720, according to one embodiment. The exemplary content 710 contains the descriptive data 720, such as in a header, although other relationships are contemplated. The content descriptive data 720 includes title data 730, keyword data 740, time data 750, and optionally other desired data 760.

A person having an ordinary level of skill in the art and having the benefit of the present teachings will appreciate that other content descriptive data may be used for other types of content, such as computer software, video games, music, electronic magazines, and other content. For example, in the case of video games, the content descriptive data may comprise a title (e.g., NCAA Football 2002), keywords (e.g., sports, football), ratings (e.g., ESRB: E (rated for everyone)), price (e.g., US $50), and other desired descriptive information.

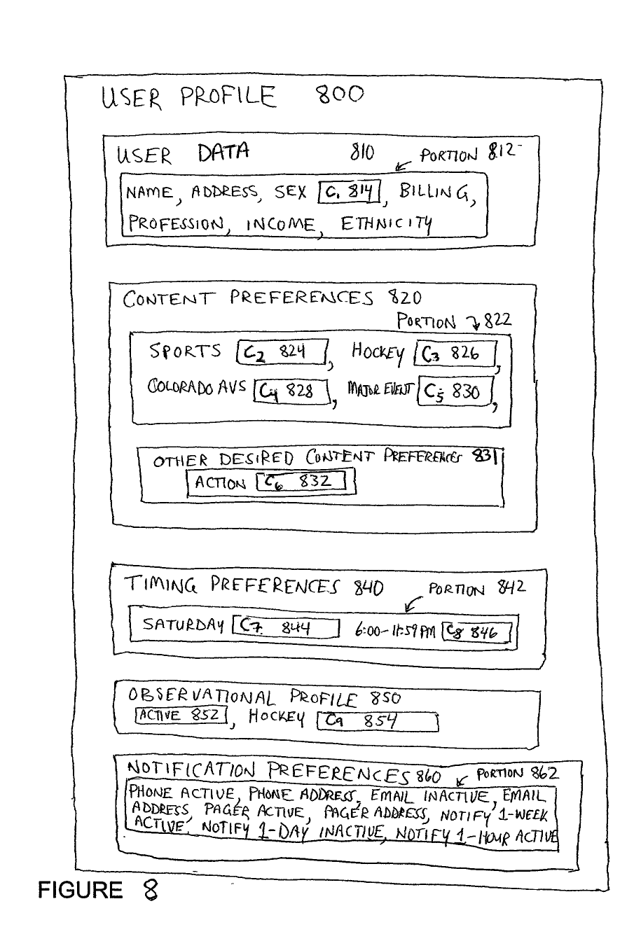

FIG. 8 conceptually illustrates a user profile 800 containing exemplary data and preferences, according to one embodiment. The user profile 800 contains user information 810, content preferences 820, timing preferences 840, observational profile data 850, and notification preferences 860.

The user data 810 contains a portion 812 that includes data about the user that may be useful for determining whether to notify the user about content, according to certain embodiments, and may be otherwise useful. The portion 812 includes an indication of the sex of the user having a corresponding contribution C1 814 to a score used to determine whether to notify the user of the content 710 shown in FIG. 7. Other data is contemplated.

The content preferences 820 contains a portion 822 that includes data about the users preferences that may be useful for determining whether to notify the user about content, according to embodiments. The portion 822 includes an indication of a preference for sports having a contribution C2 824, hockey having a contribution C3 826, Colorado Avs having a contribution C4 828, and major events having a contribution C5 830. The content preferences 820 may contain other desired content preferences 831 including an indication of a preference for action having an associated contribution C6 832.

The timing preferences 840 contains a portion 842 that includes data about when the user prefers to view content that may be useful for determining whether to notify the user about content, according to one embodiment. The portion 842 includes an indication that the user has a preference for viewing content on Saturday having a contribution C7 844, and includes an indication that the user has a preference for viewing content between 6:00-11:59 PM having a contribution C8 846.

The notification preferences 860 contain a portion 862 that includes data about how the user prefers to be notified. The portion 862 indicates that a number of notification systems are registered including a phone, email, and a pager. The portion 862 indicates that the phone is active and provides an address that is used to communicate the request for notification to the phone notification system. The portion 862 also indicates that the user prefers to be notified one week, and one hour prior to normal viewing of the content.

According to one embodiment, the notification system first determines that the contributions C1 814, C2 824, C3 826, C4 828, C5 830, C6 832, C7 844, C8 846, and C9 854 may affect whether the user should be notified. For example, the contributions C2 824, C3 826, C4 828, C5 830, and C6 832 are determined because the descriptive data 720 contains the keywords and the profile 800 contains corresponding preferences. The contribution C1 may be added by the content transmission system to reflect a difference in statistically observed preference in watching sports between men and women. The contributions C7 844 and C8 846 may be user-supplied factors that empirically quantify the users preference for watching content on Saturday and between 6:00-11:59 PM mountain standard time. These may be determined to be relevant for the content 710 due to the time data 750. The contribution C9 854 may be based on observation of actual viewing habits of the user, which in this case indicate that historically the user has viewed hockey more than would be expected from past preference estimates. For example, the user may have recently viewed several hockey events having lower estimated preference scores than other events available at the same time, and the system may introduce contribution C9 to attempt to correct for this discrepancy. Advantageously, the ability to adjust estimates based on correlation between past estimated consumption preferences and observed consumption may allow the notification to account for factors, such as the fact that the user may watch playoff hockey more than regular season hockey.

Many ways are contemplated for determining whether to notify a user based on profiles, content descriptive data, contributions, and scores. For example, considering the described contributions C1 814, C2 824, C3 826, C4 828, C5 830, C6 832, C7 844, C8 846, and C9 854, the contributions may be combined into any desired score, such as a function of the parameters f (C1 814, C2 824, C3 826, C4 828, C5 830, C6 832, C7 844, C8 846, C9 854). Without limitation, the score may be equal to [(C1)(C2)+(C3)(C9)+C4+C5+C6][C7+C8]. Alternatively, those having an ordinary level of skill in the art will appreciate that the score may be computed using other contributions and other approaches based on the present disclosure. In any event, descriptive data 720 and the profile 800 may result in a profile-based notification-triggering event.

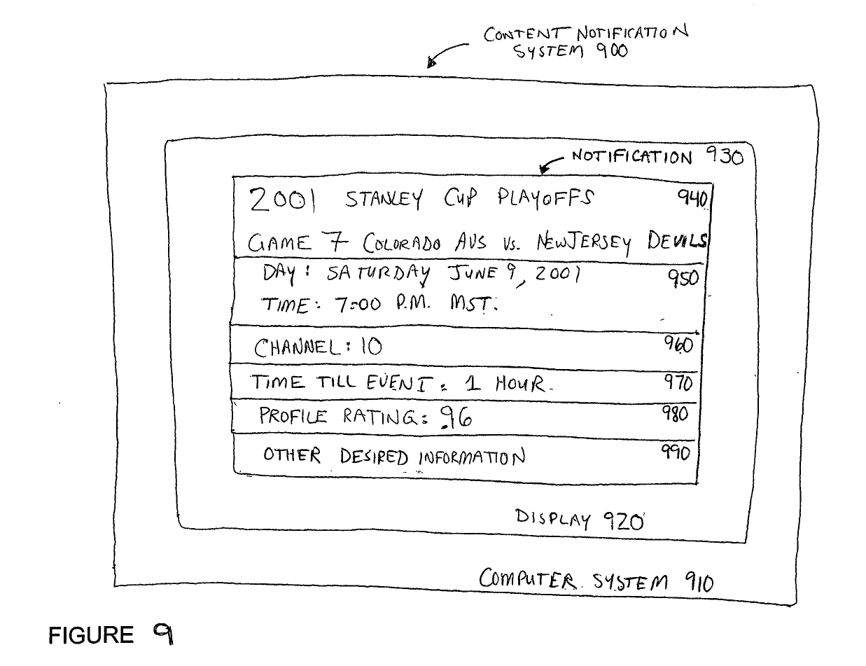

FIG. 9 conceptually illustrates a content notification system 900 presenting an exemplary notification of content 930, according to one embodiment. In this particular case, the notification system 900 includes a computer system 910, such as a personal digital assistant, and a display device 920 for presenting the notification 930, which may include text, graphics, sound, and other user stimulus. In this particular case, the notification 930 includes alphanumeric human-readable text that is useful for notifying the user of the content 710. The notification includes content summary data 940 that concisely and sufficiently describes the content 710, time data 950 that describes when the normal viewing time of the content 710 is, channel data 960 that describes how to tune and receive the content 710, time till event data 970, score data 980 that conveys expected match with the users preferences, and other information that is desired 990.

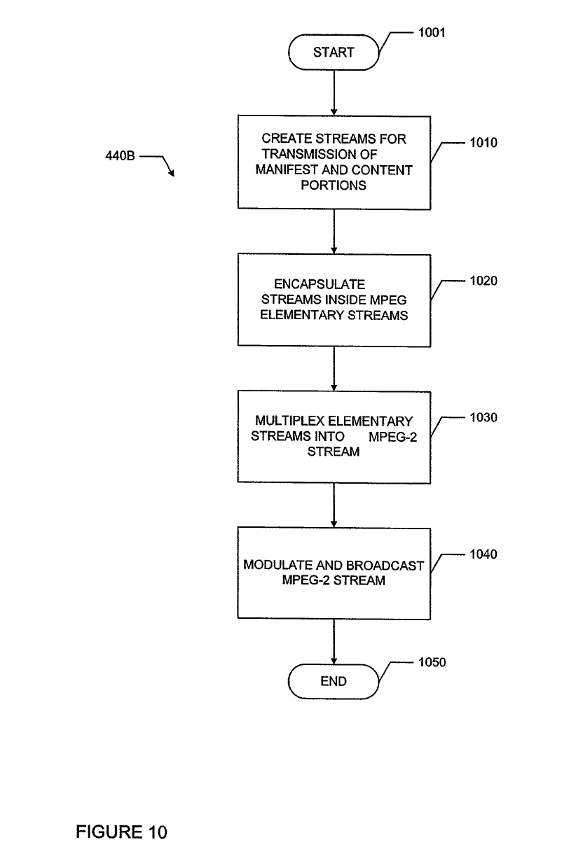

FIG. 10 conceptually illustrates in block diagram form a method 440B, according to one embodiment, for transmitting content in MPEG format. The method 440B may be implemented in logic that may include software, firmware, hardware or a combination of software, firmware, and hardware.

The method 440B commences at block 1001, and then proceeds to block 1010, where streams are created for transmission of digital content. The method 440B advances from block 1010 to block 1020 where the streams are encapsulated inside MPEG elementary streams. The method 440B advances from block 1020 to block 1030 where elementary streams are multiplexed into an MPEG-2 stream. The method 440B advances from block 1030 to block 1040 where the MPEG-2 stream is modulated and transmitted (e.g., broadcast). The method 440B terminates at block 1050.

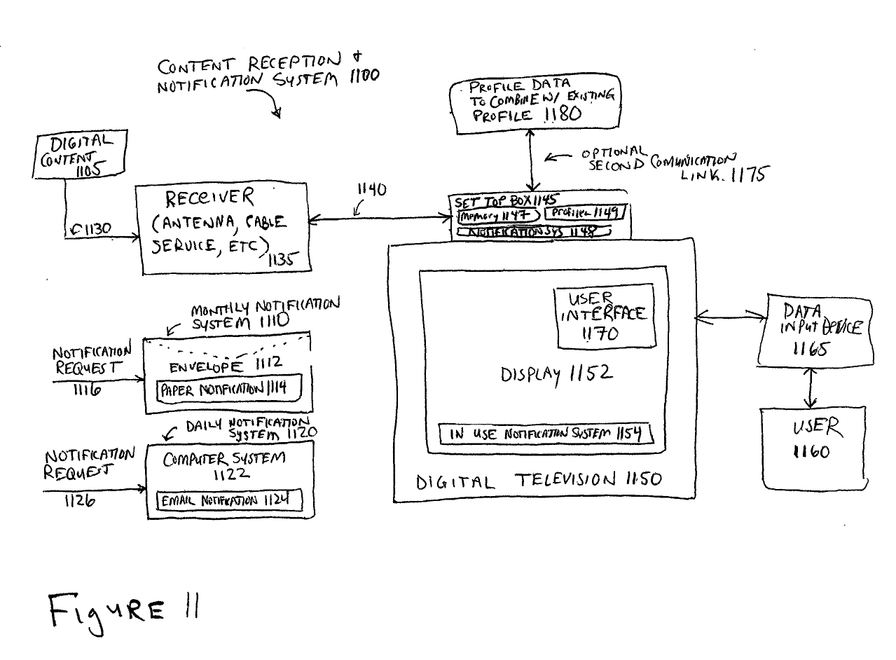

FIG. 11 conceptually illustrates an exemplary content reception and notification system 1100 including a digital television 1150 that provides content notification for content 1105 and that collects and provides profile feedback, according to one embodiment. The system 11 includes a receiver 1135 to receive content 1105 and provide the content 1105 to a set top box 1145. The receiver 1135 may be any conventional receiver. Typically, the receiver 1135 will contain hardware, such as an antenna (e.g., rabbit ears, satellite dish, etc.) or a cable outlet that interfaces to a cable service system. The receiver 1135 is functionally coupled with the set top box 1145 to provide the content 1105 to the set top box 1145 via a link 1140.

The set top box 1145 receives the content 1105 from the receiver 1135, stores the content 1105 in memory 1147, and provides the content 1105 from the memory 1147 to the digital television content presentation device 1150. The television 1150 and the box 1145 are shown to be proximate, although this need not be the case. The television 1150 includes a display 1152 (and may additionally contain speakers and other features that are not shown) to present the content 1105 to the user 1160. The digital television 1150 has a user interface 1170 to allow the user 1160 to interact with the television 1150, the set top box 1145, or both. For example, the interface 1170 may allow the user 1160 to select content to receive, select content to view, select stored content to delete, turn off the notification system, modify settings of the notification system, and make other indications that will be apparent to a person having an ordinary level of skill in the art and having the benefit of the present disclosure.

Typically, the receiver 1135, the set top box 1145, and the television 1150, are conventional components. After proper installation, the user 1160 uses the set top box 1145 and the receiver 1135 to tune into a link and receive digital content representing software instructions including instructions to perform notification processing and to profile, which are stored in the set top box 1145. Alternatively, the system 1100 may be purchased preprogrammed and ready to receive content, perform notification, and profile.

The system 1100 includes a monthly notification system 1110 that receives a notification request 1116 and that includes a mechanism to generate, address, and mail an envelope 1112 containing a paper notification of content to the user 1160 that notifies the user of content including content 1105 scheduled the following month based on the request 1116. The system 1100 also includes a daily notification system 1122 that receives notification request 1126 and that includes a computer system 1122 to provide an email notification 1124 to the user 1160 a day before the content 1105 is scheduled.

Typically close to the scheduled time for the content 1105, the content 1105 is transmitted on broadcast link 1130 to a receiver 1135 (e.g., an antenna, cable service). The receiver 1135 provides the content 1105 to the set top box 1145 via a link 1140, such as a cable, where the content 1105 is stored in memory 1147. Advantageously, the user 1160 has been notified of the content 1105 by the monthly notification system 1110 and reminded and notified of the content 1105 by the daily notification system 1120, and may use the data input device 1165 to turn on the digital television content presentation device 1150 to view the content 1105 on a display 1152. The set top box 1145 provides the television 1150 with the content 1105 from the memory 1147.

However, in the event that the user forgot about the notifications 1114, 1124, the system 1100 comprises an in use notification system 1154 to notify the user 1160 of the content 1105. For example, the user 1160 may be consuming different content when the digital content 1105 becomes available in the memory 1147 when notification 1154 comprising a beep and a moving banner notification across the bottom of the display, such as “THE MARIX IS SHOWING ON CHANNEL 31”, are presented. The user 1160 may then use the device 1165 to switch to channel 31 to view the content 1105.

The system 1100 also includes a profiling system to collect and provide profile data. The set top box 1145 includes a profiler 1149, which may include instructions to create profile data based on interaction between the user 1160 and the television 1150. For example, the profiler 1149 may observe content that the user 1160 watches, observe how long the user watches the content, and accordingly determine keywords that correlate with content the user prefers. The profiling system also includes a user interface 1170, which may be used to explicitly record user preferences. For example, after consuming the content 1105, the television 1150 may present the interface 1170 containing excellent, good, average, bad, and poor rating options that the user 1160 may select with the device 1165. The profile data 1180 is transmitted via a second communication link 1175, such as a phone line, to another entity like a transmission and reception system.

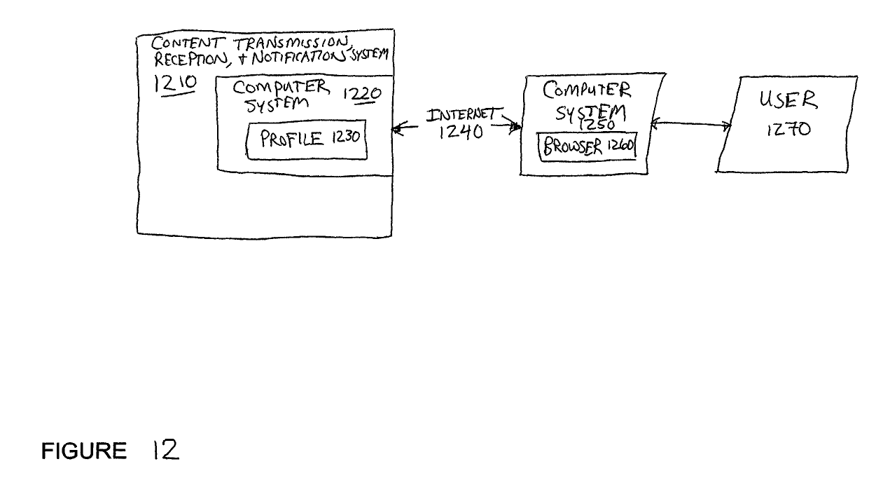

FIG. 12 conceptually illustrates an exemplary content transmission, reception, and notification system 1210 having a profile 1230 that is accessible to a user 1270 via the Internet. The user 1270 uses a computer system 1250 that may contain a browser 1260 to connect with a computer system 1220 via the Internet 1240. The computer system may be a server, such as a web server, that provides the profile 1230 to the user 1270 and optionally other users. The user 1270 may view the profile 1230, edit the profile 1230, add data to the profile 1230, delete data from the profile 1230, create a new profile, and perform other actions that may alter the way the user 1270 is notified of content.

The profile 1230 and the computer system 1220 are part of a content transmission, reception, and notification system 1210 that may access and use the profile 1230. For example, the system 1210 may access content preference data associated with the user 1270 from the profile 1230. Advantageously, in this way, the user 1270 may be able to control when and how notification occurs, which may increase the likelihood that the user 1270 is correctly notified of content of interest.

Exemplary User Notification of a Movie Delivered by Satellite Multicast IP Data

To further illustrate the invention, according to one embodiment, consider without limitation an entity associated with a content transmission system that decides to broadcast a movie M to a plurality of remote and geographically distributed reception systems. The movie M is divided into three equal-sized chunks for transmission. Each chunk is given a unique identification: C₁, C₂, and C₃. These chunks are grouped together, or “packaged,” with the unique identification P and stored in a memory.

The entity associated with the content transmission system may compare content descriptive data corresponding to the movie M and determine to notify a user of the movie M. Subsequently, at a first predetermined and scheduled time, a notification requesting system may issue a notification request to a pager notification system to cause the pager to notify the user of the movie.

At a second predetermined and scheduled time, which may be related to the first time, the transmission system accesses the package P from the memory. The transmission system may be a transmission system server S residing at a satellite uplink facility, such as a “head end”. The server may feed multicast IP data downstream to an inserter. Starting with C₁, the server encodes the data as a series of UHTTP (Unidirectional HyperText Transport Protocol) packets that are subsequently placed on the head end's local network. By way of example, each of these packets may be 2 kilobytes in size. The packets, UHTTP or otherwise may contain a prefacing header comprised of a sequence of bytes before the actual content bytes.

A data inserter watches the head end's network for multicast traffic and captures or extracts multicast IP data, such as the UHTTP packets, off the head ends network, and multiplexes them into an MPEG-2 compliant transport stream that already contains digital television elementary streams. This multiplexed stream is then fed to a modulator that is configured to take the MPEG-2 compliant transport stream and bounce if off a satellite.

A reception system in the field has a demodulator operable to convert a signal received from a satellite back into an MPEG-2 compliant transport stream. The system tunes the demodulator to an appropriate frequency and begins to receive P from the satellite. The system includes a decoder operable to extract IP data from an MPEG-2 compliant transport stream, and pipe it to a TCP/IP stack. A transmission receiver converts multicast IP data extracted from the receiver's TCP/IP stack back into a replica of the source data.

After the movie M has been sufficiently received and stored in a cache, either the transmission system or the reception system may issue a notification request to either the pager or another notification system to cause the notification system to notify the user that the movie M is ready for viewing. Such notification may make it more likely that the user watches movies of interest.

Exemplary Computer Architecture

As discussed herein, a “system” or “computer system”, such as a system for notifying a user of content, may be an apparatus including hardware and/or software for processing data. The system may include, but is not limited to, a computer (e.g., portable, laptop, desktop, server, mainframe, etc.), hard copy equipment (e.g., optical disk burner, printer, plotter, fax machine, etc.), and the like.

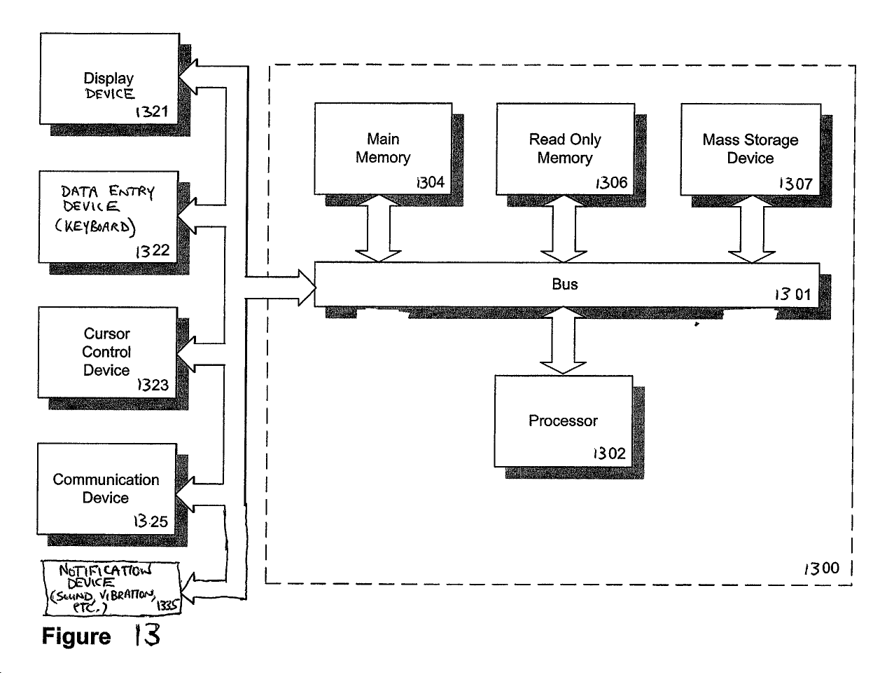

A computer system 1300 representing an exemplary workstation, host, or server in which features of the present invention may be implemented will now be described with reference to FIG. 13. The computer system 1300 represents one possible computer system for implementing embodiments, however other computer systems and variations of the computer system 1300 are also possible. The computer system 1300 comprises a bus or other communication means 1301 to communicate information, and a processing means such as processor 1302 coupled with the bus 1301 to process information. The computer system 1300 further comprises a random access memory (RAM) or other dynamic storage device 1304 (referred to as main memory), coupled with the bus 1301 to store information and instructions to be executed by the processor 1302. The main memory 1304 also may be used to store temporary variables or other intermediate information during execution of instructions by the processor 1302. In one embodiment, the main memory 1304 may be used to store the operating system, application programs, predetermined coded instructions, rule sets, data structures, and other types of data. The computer system 1300 also comprises a read only memory (ROM) and other static storage devices 1306 coupled with the bus 1301 to store static information and instructions for the processor 1302, such as the BIOS. A data storage device 1307 such as a magnetic disk, zip, or optical disc and its corresponding drive may also be coupled with the computer system 1300 to store information and instructions.

The computer system 1300 may also be coupled via the bus 1301 to a display device 1321, such as a cathode ray tube (CRT) or liquid crystal display (LCD), to display information to an end user. Typically, a data input device 1322, such as a keyboard or other alphanumeric input device including alphanumeric and other keys, may be coupled with the bus 1301 to communicate information and command selections to the processor 1302. Another type of user input device is a cursor control device 1323, such as a mouse, a trackball, or cursor direction keys, to communicate direction information and command selections to the processor 1302 and to control cursor movement on the display 1321. The system 1300 may also include a notification device such as a speaker or vibration generator and a corresponding driver to provide stimulus.

A communication device 1325 is also coupled with the bus 1301. Depending upon the particular implementation, the communication device 1325 may include a modem, a network interface card, or other well-known interface devices, such as those used for coupling to Ethernet, token ring, or other types of physical attachment for purposes of providing a communication link to support a local or wide area network, for example. In any event, in this manner, the computer system 1300 may be coupled with a number of clients or servers via a conventional network infrastructure, such as a company's intranet, an extranet, or the Internet, for example. The communication device may be used to transmit or receive data, such as a request for notification, or profile data, content, content descriptive data, or other data.

Embodiments of the invention are not limited to any particular computer system. Rather, embodiments may be used on any stand alone, distributed, networked, or other type of computer system. For example, embodiments may be used on one or more computers compatible with NT, Linux, Windows, Macintosh, any variation of Unix, or others.

The present invention includes various operations, as described above. The operations may be performed by hardware components or may be embodied in machine-executable instructions, which may be used to cause a general-purpose or special-purpose processor or logic circuits programmed with the instructions to perform the operations. The present invention may be provided as a computer program product that may include a machine-readable medium having stored thereon instructions that may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media or machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection). Alternatively, the operations may be performed by a combination of hardware and software.

In conclusion, the present invention provides an approach for improving certain aspects of data transmission. More specifically, the present invention provides an approach for using a profile to notify a user regarding content.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

[image]

[image]

What is claimed is:

1. A method comprising:
accessing content descriptive data corresponding to content operable to be transmitted to a reception system associated with a user;
accessing preference data that describes a content preference of the user;
determining to notify the user by comparing the content descriptive data with the preference data and determining that the content descriptive data matches the preference data; and
enabling notification of the user by transmitting a notification request to a notification system associated with the user.

2. The method of claim 1, wherein accessing content descriptive data includes accessing content descriptive data corresponding to digital multimedia entertainment content selected for transmission to the reception system and operable to be transmitted over a broadcast channel to the reception system which comprises a memory to store the content.

3. The method of claim 1, wherein enabling notification of the user by transmitting a notification request further comprises:
generating a notification request by using at least a portion of the content descriptive data; and
transmitting the notification request by using a predetermined stored address corresponding to the notification system.

4. The method of claim 1, wherein enabling notification of the user by transmitting a notification request to a notification system associated with the user further comprises transmitting a notification request operable to cause a notification from a notification system selected from the group consisting of a pager, and a phone.

5. A machine-readable medium having stored thereon data representing sequences of instructions that when executed cause a machine to:
access content descriptive data corresponding to content that has been selected for broadcast to a plurality of reception systems including a reception system associated with a user;
access predetermined preference data that comprises a predetermined content preference of the user and a predetermined notification preference of the user;
compare the content descriptive data with the predetermined content preference data to determine to notify the user;
generate a notification request based on the predetermined notification preference of the user; and
enable notification of the user by transmitting the notification request to a notification system associated with the user.

6. The machine-readable medium of claim 5 wherein the instructions to enable notification of the user by transmitting the notification request to a notification system associated with the user further comprise instructions causing the machine to transmit the notification request to a notification system selected from the group consisting of a personal computer, a laptop, a personal digital assistant, and an email account.

7. The machine-readable medium of claim 5:
wherein the instructions to generate a notification request based on the predetermined notification preference of the user further comprise instructions causing the machine to generate a notification request comprising a portion of the content descriptive data and a format appropriate for a requested notification system; and
wherein the instructions to enable notification of the user by transmitting the notification request to a notification system associated with the user further comprise instructions causing the machine to transmit the notification request using a predetermined address corresponding to the requested notification system.

8. A system comprising:
content descriptive data that describes digital content to be broadcast to a user;
a profile that includes content preference data for the user; and
a notification requesting system to access the content descriptive data and the profile, to compare the content descriptive data and the profile, and to issue a notification request to a notification system associated with the user if the content descriptive data matches the profile.

9. The system of claim 8, wherein the notification system is a mobile notification system.

10. The system of claim 8, wherein:
the digital content includes television programming;
the profile includes a television content preference for the user; and
the notification requesting system is a notification requesting system to generate a notification request comprising a portion of the content descriptive data and issues the request using a predetermined address of the notification system.

11. The system of claim 8, wherein:
the digital content includes digital content having a type that is selected from the group consisting of music, software, and video game; and
the profile includes a notification preference for the user.

12. The system of claim 8, wherein the profile is coupled with the user via a communication link and operable to be modified by the user.

13. The system of claim 8, wherein the profile comprises preference data that was obtained by observing and recording content consumption by the user.

14. The system of claim 8, wherein the notification requesting system is a notification requesting system to generate:
a first request at a first time prior to transmission of the content to the user to enable the notification system to notify the user of content before it is transmitted; and
a second request at a second subsequent time after transmission of the content to the user to enable the notification system to notify the user of content after it has been transmitted.

15. A system comprising:
content descriptive data associated with content;
content preference data associated with a user; and
notification means to access the content descriptive data and the content preference data and to notify the user if the content descriptive data matches the content preference data.

16. The system of claim 15, wherein the notification means comprises a notification system selected from the group consisting of: a pager, telephone, and a personal digital assistant.

17. The system of claim 15, further comprising:
the content;
a content reception system to receive the content; and
a content presentation system to present the content to the user.

18. A system comprising:
a receiver to receive broadcast content and content descriptive data;
a notification requesting system coupled with the receiver and comprising a predetermined notification system address corresponding to a notification system to receive the content descriptive data and to generate a notification request addressed to the notification system and comprising the content descriptive data; and
a transmitter coupled with the notification requesting system to receive the addressed notification request and to transmit the request to the notification system.

19. The system of claim 18:
wherein the notification system is a mobile notification system; and
wherein the notification requesting system comprises an address of the mobile a notification system.

20. The system of claim 18, further comprising:
a cache to store received content; and
a profiling system to modify a user profile by storing content descriptive data for content that the user consumes.
